(19) United States
(12) Patent Application Publication
(10) Pub. No.: US 2023/0055815 A1
(43) Pub. Date: Feb. 23, 2023

(54) INTERPLANETARY TRANSPORTATION SYSTEM

(71) Applicant: Jimmy Wagner, BROOKLYN, NY (US)

(72) Inventor: Jimmy Wagner, BROOKLYN, NY (US)

(21) Appl. No.: 17/588,341

(22) Filed: Jan. 31, 2022

Related U.S. Application Data
(60) Provisional application No. 63/235,914, filed on Aug. 23, 2021.

(51) Int. Cl. B64G 1/40; B64G 1/00; B64G 1/10; B64G 1/44

(52) U.S. Cl. CPC B64G 1/409; B64G 1/002; B64G 1/44; B64G 1/105; B64G 2001/1071; B64G 2700/00

(57) ABSTRACT

An interplanetary transportation system that includes a tunnel that spans between different planetary bodies and uses an electromagnetic propulsion system for propelling space-faring vehicles. The tunnel can be fixed and powered by outer space energy resources, such as the sunlight. The tunnels include fixed spaced rings and a mobile ring. The vehicle can be mounted to the mobile ring, wherein the spaced rings and the mobile ring propels the vehicle using motional EMF.

### CROSS-REFERENCE TO RELATED APPLICATIONS

This application claims priority from the U.S. Provisional Pat. application Ser. No. 63/235,914, filed on Aug. 23, 2021, which is incorporated herein by reference in its entirety.

### FIELD OF INVENTION

The present invention relates to an interplanetary transportation system, and more particularly, the present invention relates to a transportation track for propelling interplanetary ships.

### BACKGROUND

Interplanetary travel refers to travel between the stars and planets of a solar system. Un-crewed spacecraft and probes have traveled to most of the planets in the solar system. The first crewed spacecraft, Apollo 11, landed on Moon in 1969 and till then six crewed spacecraft have landed humans on the moon. Also, from time to time, crewed flights to Mars and Venus have been planned. The area of interplanetary travel is being explored more by humans. Vast research is undergoing to make interplanetary travel faster, economical, and safer. Most of this research is focused on improving the rocket launching and propulsion system. However, the existing propulsion systems including the rockets have several limitations or barriers which make them unsuitable for handling future spacecraft traffic in interplanetary travel. Considering the human’s plans to colonize different planets in the future, a need is there for a sophisticated transportation system for interplanetary travel to handle the outer space traffic.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an interplanetary transportation system for propelling the ships in outer space.

It is another object of the present invention that the interplanetary transportation system can handle increased outer space traffic.

It is still another object of the present invention that interplanetary transportation can be made economical.

It is still another object of the present invention that interplanetary transportation can be made faster.

It is a further object of the present invention that the interplanetary transportation system can use outer space energy sources.

It is still a further object of the present invention that combustible fuel is not used.

In one aspect, disclosed is an interplanetary transportation system that includes a tunnel that spans between different planetary bodies and uses an electromagnetic propulsion system for propelling interplanetary ships. The tunnel can be fixed and powered by outer space energy resources, such as the sunlight.

In one implementation, the tunnel can be C-shape having an open bottom through which the vehicles can be spatially suspended in outer space.

In one implementation, the disclosed interplanetary transportation system can be operated by a control unit. Alternatively, the tunnel can be operated by the incoming/outgoing ship.

In one implementation, additional vehicle members can be provided on the spaceships that can interact with the tunnel for electromagnetic propulsion of the spaceships.

In one aspect, disclosed is an interplanetary transportation system comprising a tunnel that spans between a first planetary body and a second planetary body, the tunnel has a slot at a bottom of the tunnel that extends along a length of the tunnel; a plurality of spaced rings disposed around the tunnel and spaced apart from each other throughout the length of the tunnel; a mobile ring configured to increase and decrease in size; and a vehicle mounting member coupled to the mobile ring, wherein the vehicle mounting member is configured to mount a space-faring vehicle, wherein the plurality of spaced rings and the mobile ring are configured for electromagnetic propulsion of the space-faring vehicle. The electromagnetic propulsion is based on motional electromotive force (EMF), wherein the mobile ring moves within the tunnel, wherein a current flowing in the plurality of spaced rings is in a direction that is opposite to a direction of a current flowing in the mobile ring. A change in the size of the mobile ring is proportional to acceleration or deceleration of the space-faring vehicle.

In one aspect, disclosed is a method for interplanetary transportation of a space-faring vehicle comprising the steps of providing the interplanetary transportation system; mounting the space-faring vehicle to the vehicle mounting member; and propelling the space-faring vehicle by the mobile ring. The method further includes the step of powering the tunnel using solar energy.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows an exemplary embodiment of the interplanetary transportation system, according to an exemplary embodiment of the present invention.

FIG. 2 shows a spaced ring and a mobile ring of the tunnel, according to an exemplary embodiment of the present invention.

### DETAILED DESCRIPTION

The accompanying figures, which are incorporated herein, form part of the specification and illustrate embodiments of the present invention. Together with the description, the figures further explain the principles of the present invention and to enable a person skilled in the relevant arts to make and use the invention.

Disclosed is an interplanetary transport system for propelling ships in the vacuum of outer space without burning the fuels. The disclosed interplanetary transport system can use the repelling forces of the electric currents traveling in opposite directions to propel space-faring vehicles (ships) in outer space. The vacuum in outer space provides no resistance to the propulsion of the ships forward using the repulsion forces of the electric currents.

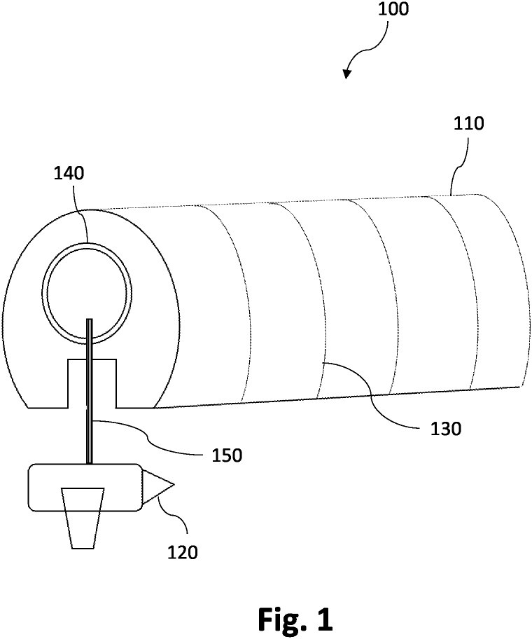

Referring to FIG. 1 which shows an exemplary embodiment of the interplanetary transport system 100 and a space-faring vehicle 120 suspended from a tunnel 110. Tunnel 110 can include spaced rings 130. The electromagnetic propulsion of the tunnel can be based on the motion EMF, wherein the tunnel can harness motional emf and converts it into a propulsion system to be used in outer space.

FIG. 1 also shows a mobile ring 140 that can increase and decrease in size to manipulate the magnetic field. Changing the size of the mobile ring 140 can depend upon whether they are used to accelerate the space-faring vehicle or slow down the space-faring vehicle leaving or coming into orbit. The disclosed system can be scaled for jumps between planets to jumps between the solar systems. The mobile ring 140 starts wide and decreases in size getting tighter and tighter. The vehicle mounting member 150 can be coupled to the mobile ring 140. The space-faring vehicle 120 can mount to the vehicle mounting member 150, wherein the mobile ring 140 can accelerate or decelerate the space-faring vehicle 120 in the outer space.

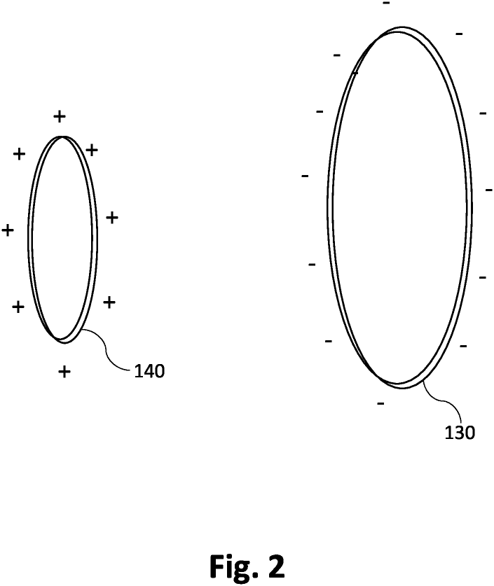

Referring to FIG. 2 which shows the flow of current in the spaced ring 130 and the mobile ring 140, wherein the flow of current in the mobile ring 140 can be opposite to the flow of current in the spaced ring 130, wherein the opposite charges can propel the spaceship forward. The change in the size of the mobile ring can be proportional to the accel eration or deceleration of the space-faring vehicle. The pilots of the vehicle or through a control center, the change in the size of the mobile ring, and thus the acceleration and deceleration of the vehicle.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An interplanetary transportation system comprising:
a tunnel that spans between a first planetary body and a second planetary body, the tunnel has a slot at a bottom of the tunnel that extends along a length of the tunnel;
a plurality of spaced rings disposed around the tunnel and spaced apart from each other throughout the length of the tunnel;
a mobile ring configured to increase and decrease in size; and
a vehicle mounting member coupled to the mobile ring, wherein the vehicle mounting member is configured to mount a space-faring vehicle,
wherein the plurality of spaced rings and the mobile ring are configured for electromagnetic propulsion of the space-faring vehicle.

2. The interplanetary transportation system according to claim 1, wherein the electromagnetic propulsion is based on motional electromotive force (EMF), wherein the mobile ring moves within the tunnel, wherein a current flowing in the plurality of spaced rings is in a direction that is opposite to a direction of a current flowing in the mobile ring.

3. The interplanetary transportation system according to claim 2, wherein a change in the size of the mobile ring is proportional to acceleration or deceleration of the space-faring vehicle.

4. A method for interplanetary transportation of a space-faring vehicle comprising the steps of:
providing an interplanetary transportation system comprising:
a tunnel that spans between a first planetary body and a second planetary body, the tunnel has a slot at a bottom of the tunnel that extends along a length of the tunnel,
a plurality of spaced rings disposed around the tunnel and spaced apart from each other throughout the length of the tunnel,
a mobile ring configured to increase and decrease in size, and
a vehicle mounting member coupled to the mobile ring, wherein the vehicle
mounting member is configured to mount the space-faring vehicle,
wherein the plurality of spaced rings and the mobile ring are configured for electromagnetic propulsion of the space-faring vehicle;
mounting the space-faring vehicle to the vehicle mounting member; and
propelling the space-faring vehicle by the mobile ring.

5. The method according to claim 4, wherein electromagnetic propulsion is based on motional electromotive force (EMF), wherein the mobile ring moves within the tunnel, wherein a current flowing in the plurality of spaced rings is in a direction that is opposite to a direction of a current flowing in the mobile ring.

6. The method according to claim 5, wherein a change in the size of the mobile ring is proportional to acceleration or deceleration of the space-faring vehicle.

7. The method according to claim 6, wherein the method further comprises the steps of:
powering the tunnel using solar energy.
